(19) United States
(12) Patent Application Publication
(10) Pub. No.: US 2010/0082758 A1
(43) Pub. Date: Apr. 1, 2010

(54) GLOBAL EMAIL ADDRESS REPUTATION SYSTEM

(76) Inventor: Tal Golan, Irvine, CA (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/242,664

(22) Filed: Sep. 30, 2008

(51) Int. Cl. G06F 15/16; G06F 17/30

(52) U.S. Cl. 709/206; 707/E17.032

(57) ABSTRACT

Systems and methods of filtering received messages to discard unsolicited messages using Silverlist filters and combinations of Silverlist filters and other types of filters are disclosed. In many embodiments, an appliance remote from a mail server is used to filter messages using at least a Silverlist filter prior to forwarding messages to the mail server. In a number of embodiments, a mail server applies a filtering process that includes a Silverlist filter and a challenge response filter. One embodiment of the invention includes a plurality of mail servers configured to maintain user mail accounts from which electronic mail messages can be exchanged via a network, a plurality of mail processing units connected to the network, where each mail processing unit acts as a gateway for at least one of the mail servers that filters incoming electronic mail messages, a global address reputation server connected to a global address reputation database and configured to communicate with the mail processing units via the network. In addition, at least one of the mail processing units is configured to track events associated with the filtering of electronic mail messages and forward tracked event information to the global address reputation server, the global address reputation server is configured to store event information received from the mail processing units in the global address reputation database, the global address reputation server is configured to develop sender reputation information concerning message senders from the event information stored in the global address reputation database, the global address reputation server is configured to provide sender reputation information concerning message senders to mail processing units, and at least one of the mail processing units that receives sender reputation information from the global address reputation server is configured to utilize the sender reputation information when filtering messages based upon the message sender.

### BACKGROUND

The present invention relates generally to message processing systems and more specifically to message processing systems that filter messages believed to be unsolicited advertisements based upon the reputation of the message's sender.

Unsolicited messages can pose a significant problem for users of message services such as email. U.S. patent application Ser. No. 12/136,697 to Golan et al. entitled “Electronic Mail Processing System Including Silverlist Filtering” discloses systems that use temporary failures to prevent users from receiving unsolicited messages sent from bulk mailing systems that do not fully implement SMTP. Many of the systems disclosed in U.S. patent application Ser. No. 12/136,697 also utilize a challenge and response process, which can be referred to as “sender address verification”, to verify that messages received by a mail server were sent by a human prior to forwarding the message to the recipient's mailbox. Silverlist filtering and sender address verification are both processes that are designed to filter unsolicited messages without generating false positives.

Each temporary failure and sender address verification issued by a mail server introduces a delay in the receipt of a mail message. U.S. patent application Ser. No. 12/136,697 describes techniques for collecting reputation information using the J.P. addresses of mail servers that successfully pass Silverlist filter tests. The reputation information can be used to accept messages based upon the I.P. address of the mail servers sending the messages. Similarly, reputation information is collected concerning senders that successfully respond to sender address verifications, which can be relied upon to pass messages from senders without performing sender address verification. The disclosure of U.S. patent application Ser. No. 12/136,697 is incorporated herein by reference in its entirety.

### SUMMARY OF THE INVENTION

Systems and methods of building a global database of sender reputation and for distributing global reputation information to mail filters are described. One embodiment of the invention includes a plurality of mail servers configured to maintain user mail accounts from which electronic mail messages can be exchanged via a network, a plurality of mail processing units connected to the network, where each mail processing unit acts as a gateway for at least one of the mail servers that filters incoming electronic mail messages, a global address reputation server connected to a global address reputation database and configured to communicate with the mail processing units via the network. In addition, at least one of the mail processing units is configured to track events associated with the filtering of electronic mail messages and forward tracked event information to the global address reputation server, the global address reputation server is configured to store event information received from the mail processing units in the global address reputation database, the global address reputation server is configured to develop sender reputation information concerning message senders from the event information stored in the global address reputation database, the global address reputation server is configured to provide sender reputation information concerning message senders to mail processing units, and at least one of the mail processing units that receives sender reputation information from the global address reputation server is configured to utilize the sender reputation information when filtering messages based upon the message sender.

In a further embodiment, each electronic mail message includes a sender email address, a sender domain, and a sender I.P. address that identify the message sender.

In another embodiment, the sender reputation information includes information concerning the reputation of a sender email address.

In a still further embodiment, the sender reputation information includes information concerning the reputation of a sender domain.

In still another embodiment, the sender reputation information includes information concerning the reputation of a sender I.P. address.

In a yet further embodiment, at least one of the mail processing units is configured to utilize at least one of the sender email address, sender domain and sender I.P. address of an incoming electronic mail message when filtering the incoming electronic mail message.

In yet another embodiment, the at least one mail processing unit is configured to forward incoming messages from senders known to have a good reputation to a mail server associated with the recipient of the message.

In a further embodiment again, the at least one mail processing units is configured to determine that a message sender has a good reputation when the sender email address, and sender I.P. address correspond to an email address and sender I.P. address pair entry on an accept list.

In another embodiment again, the email address and sender I.P. address pair is expressed as a hash value on the accept list.

In a further additional embodiment, at least one mail processing unit is configured to determine the reputation of senders that have an unknown reputation by performing a fundamental SMTP behavior test.

In another additional embodiment, the fundamental SMTP behavior test is a Silverlist test; and at least one mail processing unit is configured to communicate the outcome of the Silverlist test to the global address reputation server.

In a still yet further embodiment, the at least one mail processing unit is configured to refuse to accept messages from senders that fail a SilverList test.

In still yet another embodiment, the at least one mail processing unit is configured to determine the reputation of senders that have an unknown reputation by performing a challenge response test.

In a still further embodiment again, the at least one mail processing unit is configured to reject messages when a sender fails a challenge response test.

In still another embodiment again, the at least one mail processing unit is configured to communicate the outcome of the challenge response test to the global address reputation server.

In a still further additional embodiment, the at least one mail processing unit is configured to determine that a sender has a good reputation when the sender passes a fundamental SMTP behavior test and a challenge response test.

In still another additional embodiment, the at least one mail processing unit is configured to filter incoming messages from senders of unknown reputation using a content based filter.

In a yet further embodiment again, the global address reputation system is configured to build a profile of a domain using reputation information provided to the global address reputation system by at least one of the mail processing units.

In still another embodiment again, the global address reputation system is configured to build a profile of a domain that includes the I.P. addresses associated with the domain using reputation information provided by at least one of the mail processing units that identifies at least one I.P. address from which messages from the domain were sent.

In a yet further additional embodiment, the global address reputation system is configured to build a profile of a domain that includes the sender email addresses associated with the domain using reputation information provided by at least one mail processing unit that identifies at least one sender email address associated with messages sent from the domain.

In yet another additional embodiment, the global address reputation system is configured to build a profile of a domain that includes the sender email addresses and I.P. addresses associated with the domain using reputation information provided by at least one mail processing unit that identifies at least one sender email addresses and I.P. address associated with messages sent from the domain.

In a further additional embodiment again, the global address reputation system is configured to enable a domain administrator to edit a domain profile and certify the accuracy of the domain profile.

In another additional embodiment again, the global address reputation system is configured to distribute certified domain profiles to at least one of the mail processing units, and the at least one mail processing unit is configured to use the certified domain profiles to filter messages from senders of unknown reputation.

In a still yet further embodiment again, at least one of the mail processing units is configured to request sender reputation information from the global address reputation system via the network in response to an incoming electronic mail message from a sender of unknown reputation, the global address reputation system is configured to respond to a request from a mail processing unit by providing sender reputation information to the requesting mail processing unit, and the at least one mail processing unit is configured to utilize the sender reputation information when filtering the electronic mail message from the sender of unknown reputation.

In still yet another embodiment again, at least one of the mail processing units is configured to store global address reputation information received from the global address reputation server for later use in the filtering of messages from senders of unknown reputation.

In a still yet further additional embodiment, at least one of the mail processing units is configured to observe endorsements of a sender and communicate the endorsements to the global address reputation system.

In still yet another additional embodiment, the at least one mail processing unit is configured to record a user sending an outgoing message addressed to a sender email address through a mail processing unit from a mail server where the user maintains a user account as an endorsement of the sender email address.

In a yet further additional embodiment again, the at least one mail processing unit is configured to record the addition of a sender email address to a list of contacts on a mail server where a user has an email account and for which the mail processing unit acts as a gateway device as an endorsement of the sender email address.

In yet another additional embodiment again, the at least one mail processing unit is configured to record a user instruction to the mail processing unit to forward a message held by the mail processing unit that was sent by a sender as an endorsement of the sender.

In another further embodiment, the global address reputation server is configured to provide devices that are not part of the electronic mail filtering system with access to global reputation information.

An embodiment of the method of the invention includes receiving inbound messages prior to receipt by a mail server, accepting messages where the sender of the message is known to have good reputation, observing the actions of senders of unknown reputation in response to at least one test intended to verify that the sender and the sender's mail server behave in a manner consistent with a sender of good reputation, forwarding reputation information including observed actions of senders in response to at least one test to a global address reputation system, receiving global reputation information from the global address reputation system, and determining senders known to have good reputation using the global reputation information.

A further embodiment of the method of the invention includes receiving inbound messages prior to receipt by one of a plurality of mail servers, where each of the messages includes an J.P. address, and a sender email address including a domain, filtering the messages based upon reputation formed by observing the actions of the sender including the sender's responses to at least one test intended to verify that the sender and the sender's mail server behave in a manner consistent with a sender of good reputation, recording the J.P. address, sender email address, and domain of received messages, and building a profile of a domain that includes the I.P. addresses and sender email addresses of all messages received from the domain and the reputation of the J.P. addresses and sender email addresses.

Another embodiment of the method of the invention includes granting an authorized domain administrator access to edit the profile, and allowing the authorized domain administrator to certify the accuracy of the profile.

### BRIEF DESCRIPTION OF THE DRAWINGS

FIG. 1 is a schematic diagram of a network including a global address reputation system in accordance with an embodiment of the invention.

FIG. 2 is a process for collecting and distributing global reputation information in accordance with an embodiment of the invention.

FIG. 3 is a block diagram that conceptually illustrates the generation of event information, incorporation of event information into a global address reputation database, and the mining of the database to produce global reputation information in accordance with embodiments of the invention.

### DETAILED DESCRIPTION OF THE INVENTION

Turning now to the drawings, mail filtering networks including a global address reputation system in accordance with embodiments of the invention are shown. In many embodiments, the global address reputation system includes a number of mail processing units that filter mail messages. As the mail processing units filter mail messages, the mail processing units collect local reputation information concerning the message senders and forward the local reputation information to a global address reputation server. Reputation information can include a variety of information concerning a sender and is not limited to information concerning whether unsolicited email has been sent from the sender's email address. In many embodiments, reputation information includes information concerning sender behavior and the configuration of a mail system where a sender maintains an email account. The global address reputation server provides global address reputation information to mail processing units to enable the mail processing units to detect spam using fewer Silverlist and sender address verification tests. In many embodiments, the global address reputation server provides reputation information concerning email addresses, domains and/or I.P. addresses. The reputation can be a binary accept/process reputation or the reputation can be provided as a score that can be used by mail processing units to decide whether to accept or process an incoming message.

In a number of embodiments, the overall filtering network relies on human factors as opposed to statistical analysis of message content and/or message traffic in making decisions concerning whether to accept or hold mail messages. The actions of individual human users are documented and used to generate global reputation information, which is then used as the basis for performing filtering decisions. Reliance on human factors enables reputation information to be built based upon actual information concerning a specific sender, mail server, and/or domain and not estimated based upon correlations with previously observed behavior.

In many embodiments, the global address reputation server is able to build a profile of a domain. An administrator for a trusted domain can review the domain profile and certify email addresses and I.P. addresses as reputable sources of email from within the domain. In a number of embodiments, knowledge of I.P. addresses certified as being within a domain can be used to detect phishing scams.

### Global Address Reputation Systems

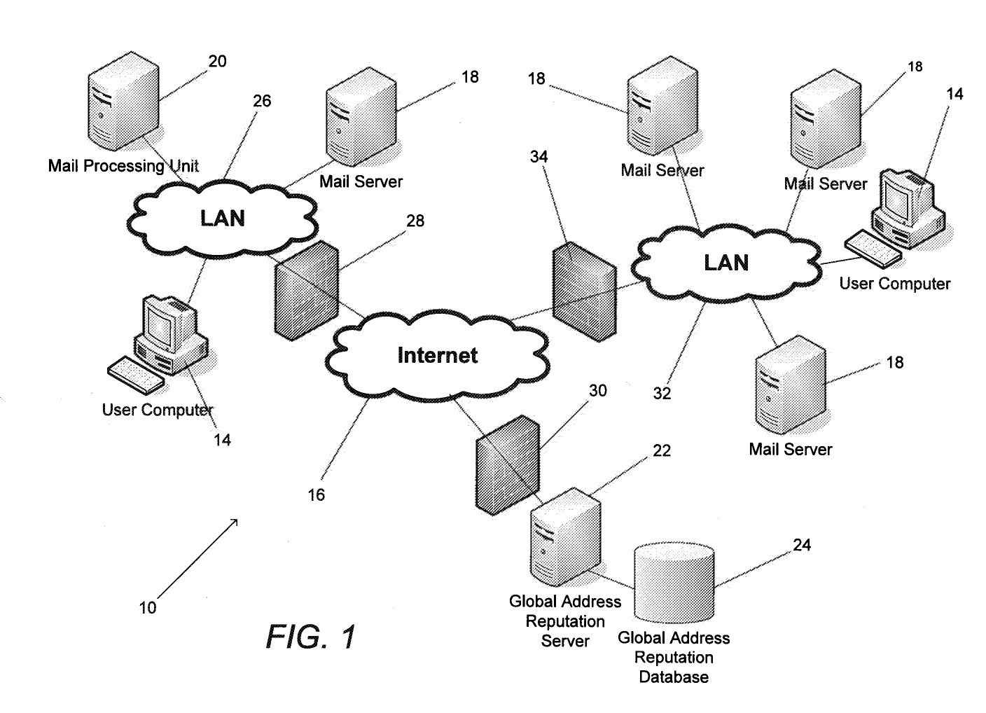

A system for sending email including a global address reputation system in accordance with an embodiment of the invention is illustrated in FIG. 1. In the illustrated embodiment, messages can be sent via user computers 14 over a network such as the Internet 16. Each user computer has a mail client application that enables the user to send messages and receive messages via a mail server 18. The global address reputation system includes a number of mail processing units 20 that filter messages destined for one or more mail servers and accumulate local reputation information. The global address reputation system also includes a global address reputation server 22 that is connected to a global address reputation database 24. The global address reputation server 22 communicates with mail processing units 20 and accumulates reliable local reputation information concerning senders in the global address reputation database 24. In many embodiments, the mail processing units periodically download global reputation information from the global address reputation server and use the global reputation information in the processing of incoming mail. In a number of embodiments, users are able to define the manner in which different pieces of global reputation information are used in performing mail processing. In this way, different users can define different risk profiles in accordance with their specific requirements. In many embodiments, the global address reputation server distributes reputation information concerning email addresses, domains, and/or I.P. addresses. The reputation information can be in a binary accept/process form, a three state accept/deny/process form, or as a reputation score that can be used by mail processing units to evaluate whether to automatically accept a received mail message or whether to process the message normally using tests such as a fundamental SMTP behavior test and/or sender address verification tests to determine whether to accept the message. In a number of embodiments, the global reputation information includes email addresses, domains and/or I.P. addresses that are known to be sources of spam. In several embodiments, a mail processing unit can request reputation information for a specific sender email address, domain and/or I.P. address from a global address reputation server. The accumulation and use of global reputation information are discussed further below.

### Mail Processing Units and Reputation Servers

Mail systems that include global address reputation systems include mail processing units that filter mail messages and a global address reputation server that manages reputation information stored in a global address reputation database. Mail processing units can be incorporated into mail systems in a variety of ways. In the embodiment illustrated in FIG. 1, a user computer 14, a mail server 18, and a mail processing unit 20 are connected via a Local Area Network (LAN) 26, which is connected to the Internet 16 via a firewall 28. In this configuration, all messages addressed to user accounts maintained by the mail server and routed via the mail processing unit, which acts as a gateway to the mail server that processes received messages to discard unsolicited email. Embodiments of mail processing units and various other configurations in which mail processing units can be deployed, including configurations where the mail processing unit and mail server are integrated and configurations where the mail processing unit filters mail for multiple mail servers associated with separate entities, are disclosed in U.S. patent application Ser. No. 11/745,950 and U.S. patent application Ser. No. 12/136,697, the disclosure of which is incorporated by reference herein in its entirety.

A global reputation server 22 and global address reputation database 24 are typically connected to the Internet 16 via a firewall 30. In a number of embodiments, multiple mirrored reputation servers are connected to the Internet. Reputation information from multiple reputation servers can be propagated in a peer-to-peer fashion or forwarded to a master reputation server that distributes database updates to all reputation servers.

### Collecting and Sharing Reputation Information

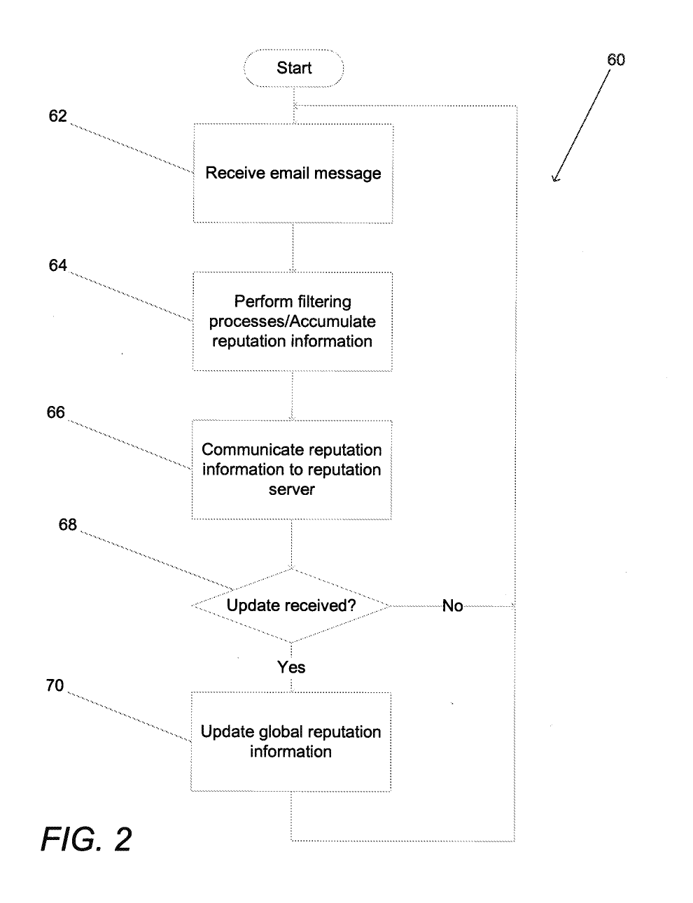

A process for collecting and sharing reputation information in accordance with an embodiment of the invention is shown in FIG. 2. The process 60 includes receiving (62) email messages and processing (64) the messages to deny spam messages. During the processing of received messages, local reputation information is collected concerning the sender's email address, the sender's domain, the sender's I.P. address and/or whether the sender exhibits behavior characteristic of senders of unsolicited messages (e.g., failure to resend in response to a temporary failure, failure to respond to a sender address verification, etc.). The type and manner in which information is collected depends largely upon the type of filters that are applied to incoming messages. Various examples of the types of local reputation information that can be collected are discussed below. In a number of embodiments, the tests used to collect information concerning a sender attempt to determine whether the sender and/or the sender's mail server behave in a manner consistent with the behavior of a sender with “good” reputation.

In a number of embodiments, the mail processing units accept messages from senders known to have a “good” reputation, reject messages from senders known to have a “bad” reputation, and/or apply a Silverlist filter and sender address verification to messages of unknown reputation. The mail processing units can rely upon local reputation information (i.e., reputation information collected by the mail processing unit) or global reputation information (i.e., reputation information received from the global address reputation server). As is discussed further below, individual users can define characteristics indicative of “good” reputation and “bad” reputation. The definitions of “good” reputation and “bad” reputation need not be universal across all users.

Filtering processes applied to messages of unknown reputation can yield reliable local reputation information concerning a sender. When a sender passes a fundamental SMTP behavior test, such as a Silverlist test, positive reputation information concerning the sender's I.P. address can be inferred from the fact that issuing a temporary failure to the sender's I.P. address resulted in the message being resent. Fundamental SMTP behavior tests are tests that are designed to verify that a sender's mail server behaves in a manner that is consistent with a full implementation of SMTP. Other fundamental SMTP behavior tests in accordance with embodiments of the invention include verifying the existence of MX, A and reverse pointer records on a mail server. Fundamental SMTP behavior tests, such as a Silverlist test, can also provide information concerning multiple I.P. addresses that can be associated with a sender's email address and a sender's domain (the I.P. address of the resend may not match the original I.P. address when the message is sent from a mail server that is part of a server farm). Similarly, verification of a sender's email address by a challenge response is a reliable basis for assigning a “good” reputation to a sender's email address. Although specific tests are discussed above, reputation information can be collected during the application of other mail processing techniques.

Local reputation information collected during the processing of received messages is communicated (66) to a global address reputation server. In many embodiments, the local reputation information is uploaded to the global address reputation server as a batch on a periodic basis (e.g., every 5 minutes). In other embodiments, information is sent to the global address reputation server as the mail processing unit processes incoming messages. In a number of embodiments, a mixture of real time reporting and batch reporting is used depending upon the value of the reputation information.

The process determines (68) whether a reputation information update has been received from the global address reputation server. In the event that an update has not been received, then the global address reputation server continues to process received messages using existing reputation information. When an update is received, the global reputation information is used to update (70) local accept and deny lists. In many embodiments, the local accept and deny lists are updated according to rules defined by the user. Various ways in which global reputation information can be used to formulate local accept and deny lists are discussed further below.

### Building a Global Address Reputation Database

The composition of the global address reputation database typically depends upon the type of local reputation information collected by mail processing units within a global address reputation system. In a number of embodiments, mail processing units track different events associated with the processing of received mail and forward the events to the global address reputation server. The global address reputation server can process the events for inclusion into a database that can then be queried to extract global reputation information. Embodiments of global address reputation systems that determine global reputation by tracking events are discussed below. In other embodiments, various techniques are used to generate global reputation information including processing the occurrence of events to produce local reputation information and communicating all or a subset of the local reputation information to a global address reputation server.

### Tracking Events

A mail processing unit in accordance with many embodiments of the invention collects information concerning events associated with the processing of mail messages, and/or its status. Examples of mail processing related events that can be tracked include receipt of a request to create an SMTP connection by a mail processing unit, the result of a Silverlist test, receipt of an inbound or outbound message by a mail processing unit, a sender address verification being sent, a verification response being received, a message being deleted (i.e., discarded due to failure to respond to a Silverlist test or sender address verification test within a predetermined time window), and results from analysis of the content of a message (e.g., the results of a virus scan, a domain keys result, a DKIM result, an SPF result, etc.). When information is collected concerning an event, information in addition to the occurrence of the event is collected. The mail processing unit also collects information concerning the sender that becomes known as a result of the occurrence of the event. For example, sender email address, sender domain, and sender I.P. address can be collected when a request to create an SMTP connection is received, and header information can be collected when an email is accepted by a mail processing unit.

Examples of system status related events that can be tracked include a user endorsement of a sender email address (e.g., a user sending a message to a sender's email address, a user creating a contact including the sender email address, a user manually accepting a message from a sender, and/or a user manually adding a sender email address or a sender domain to an accept list), system uptime and system clock, system memory statistics and usage information, system process statistics and usage information, system network received/sent statistics and usage information, system CPU statistics and usage information, disk size information, and software version. User endorsements can be particularly useful in accumulating reputation information. A user endorsement is typically considered to be any action by one user that positively (or negatively) reflects upon the reputation of the endorsed user (which may in fact be a self endorsement). Examples of positive user endorsements include, responding to various mail filtering tests, sending an email to a user, adding a user to contacts, adding a user to an accept list, and adding a domain to an accept list. Whether a user action constitutes an endorsement often depends upon the application. In many embodiments, other sets of events can be tracked by mail processing units according to the manner in which the mail processing units handle received mail messages and the requirements of the application.

Loading Event Information into a Global Address Reputation Database

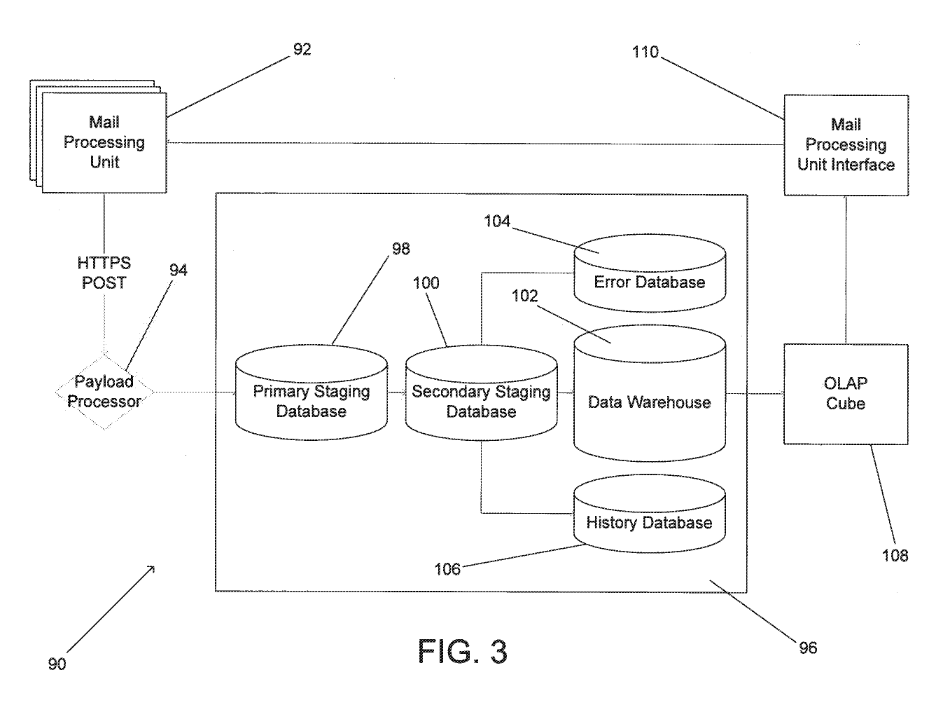

In a number of embodiments, tracked events are forwarded to a global address reputation server. A diagram conceptually illustrating the incorporation of event information into a global address reputation database is shown in FIG. 3. The system 90 for collecting and distributing global address reputation information includes a number of mail processing units 92 that track events similar to those described above. Periodically, the mail processing units send information concerning the tracked events to the global address reputation server. In many embodiments, the tracked event information is stored in an XML format and transmitted over a secure link such as using Hypertext Transfer Protocol over Secure Socket Layer (HTTPS). In many embodiments, the XML information is compressed. A process on the global address reputation server that can be referred to as the payload processor 94 decompresses and extracts the event information and provides the event information to a database management system 96. In a number of embodiments, the XML is translated into CSV (comma separated values) to facilitate data import via XLST (Extensible Stylesheet Language Transformations).

In a number of embodiments, the database management system is a SQL RDBMS such as the open source PostgreSQL DMS. In order to process the large amounts of event data generated by the mail processing units, the database management system loads the event information into a number of staging databases. In the illustrated embodiment, the payload processor loads the received XML information into a primary staging database 98 containing XML information. The events stored in the primary staging database 98 are then processed to modify the objects specified in the events as they exist in a second staging database 100. A series of SQL Stored Procedures are called to perform the transformation of the objects in the second staging database. Effectively, the events as-they-happen on the global address reputation system are stored in the primary staging database, and constructed objects are stored and modified in the secondary staging database. The separation of the stages can be both a natural means of storing all of the data form the payloads in a relational database, and storing the objects data that are being tracked. The separation of the stages also provides a physical separation of the databases, so that each of the stages can be handles by separate machines or separate clusters of machines. Event information in the secondary staging database 100 that is relevant to sender address reputation is then loaded into a data warehouse 102, which is a relational database. In a number of embodiments SQL Stored Procedures are also used to load the data into the data warehouse. Information from the secondary staging database is also loaded into a history database 106. The history database is very similar to the secondary staging database in that the history database has the same information without any constraints with additional timestamp information. The timestamp information enables system administrators to go back in time, and recreate the data warehouse.

Event data that could not be processed properly is loaded into an error or exception database 104. The error database often contains XML information concerning events, where the XML was only able to be partially parsed.

Over time the global address reputation server can store a vast amount of data in the data warehouse. Therefore, data from the data warehouse 102 can be loaded into an Online Analytic Processing (OLAP) cube 108, or another type of data structure that is useful in the near instantaneous analysis and display of relational data within the data warehouse. The OLAP cube 108 can then be used in the analysis of data within the data warehouse. Global reputation information can be developed using the OLAP cube 108 and a mail processing unit interface 110 used to communicate the global reputation information back to the mail processing units 92. In many embodiments, an HTTP client is used to communicate the reputation information back to the mail processing units. In this way, local reputation information is collected through the analysis of the tracked event reports provided to the global address reputation server by the mail processing system. The local reputation is aggregated over a large number of mail processing units and analyzed to draw conclusions concerning the global reputation of different sender email addresses, sender domains, I.P. addresses, combinations of sender email addresses and I.P. addresses, and combinations of sender domains and I.P. addresses. The global reputation information is then communicated back the mail processing units, which use the global reputation information in the processing new mail messages.

Although a specific system for transforming, organizing, and analyzing event information is shown in FIG. 3. Other systems in accordance with embodiments of the invention can be utilized to process event information to obtain global reputation information. In many embodiments, mail processing units process basic event information and transmit reputation information derived from analysis of event information. In other embodiments, systems appropriate to the application are used.

Extracting Reputation Information from the Global Address Reputation Database

A vast amount of event information can be collected in a global address reputation database in accordance with embodiments of the invention. The manner in which global reputation information is determined based upon the event information is largely dependent upon the collected event information and the requirements of the application. In many embodiments, global reputation is developed separately for sender email addresses, sender domains, and I.P. addresses. Global reputation can also be developed for combinations of sender email addresses, and I.P. addresses, and sender domains, and I.P. addresses. The manner in which global reputation is developed is largely dependent upon the perceived value of different pieces of local reputation information collected by mail processing units. Events that document actions of a sender can be considered to yield reputation information that is more valuable than events that document an endorsement of a sender. The values that can be attributed to reputation information developed by observation of various events are discussed further below.

### Attributing Values to Local Reputation Information

Reputation information can be collected from events received from mail processing units that document a sender's response to tests such as sender address verification and/or a Silverlist test, and from events that include an endorsement of the reputation of a specific sender or domain. In several embodiments, reputation information collected from events that document observations of sender behavior is given more weight in formulating global reputation than reputation information collected from events that document one user's endorsement of another user. The reason is that an individual user's willingness to accept mail from a sender is not necessarily a reliable indication that other users would welcome messages from the endorsed sender. In this way, the global address reputation system can prevent a single user's endorsement of a spammer from exposing all other users to spam.

When a sender is endorsed without a sender address verification, the fact that a sender acquired “good” local reputation via a user endorsement does not mean that valuable global reputation information cannot be collected from events related to messages received from the endorsed sender. Receipt of a message from the endorsed sender verifies that the endorsed sender email address is in fact a valid address. In addition, received messages can be used to collect one or more I.P. addresses associated with the sender's email address and the sender's domain.

As more reputation information is collected, additional factors and patterns that indicate “good” or “bad” global reputation are likely to emerge. Therefore, many global address reputation systems provide tools for analyzing collected reputation information and modifying the manner in which determinations of global address reputation are performed in response to the analysis of the collected reputation information. Accordingly, the manner in which global reputation systems in accordance with embodiments of the invention determine global reputation based upon collected reputation information can change over time based upon observations of factors that correlate with “good” or “bad” reputation.

### Aggregation of Reputation Information

The ability of a global address reputation server to aggregate event information from multiple mail processing units ultimately means that event reports containing I.P. addresses associated with a sender email address from a first mail processing unit, where the sender was endorsed, can be considered in combination with event reports from other mail processing servers in considering the global reputation to assign the sender. As more information is aggregated concerning a sender, including sender address verifications performed by mail processing units where the sender does not enjoy an endorsement, a more accurate assessment of the global reputation of a sender can be constructed.

### Building Profiles of Mail Systems

Reputation information aggregated by a global address reputation server can contain information concerning associations between user mailboxes and domains, and I.P. addresses and domains. In many instances, the global address reputation database can profile mail systems by developing a listing of mailboxes (i.e., sender emails accounts) and I.P. addresses associated with a domain. The global address reputation database can also detect multiple mail systems hosted on a particular server or servers by developing a listing of the domains associated with an I.P. address. As is discussed further below, the ability to profile mail systems enables the administrators of each mail system to identify legitimate senders and senders that are not legitimately associated with the domain.

### Certification of Reputation Information

The ability of global address reputation servers in accordance with embodiments of the invention to profile domains enables domain administrators to certify the accuracy of a domain profile. A domain administrator is someone authorized by the owner of one or more domains to certify the accuracy of information collected about the domain including the I.P. addresses associated with the domain and the sender email addresses associated with the domain. A domain profile is certified when a domain administrator certifies that the information within a domain profile is accurate. In a number of embodiments, domain administrators can communicate with the global address reputation server via a user interface that enables the domain administrator to confirm which of the mailboxes and I.P. addresses within one or more domains are valid. The domain administrator can also indicate which of the mailboxes and I.P. addresses is not legitimate. In this way, the domain administrator can provide extremely valuable reputation information that can be used in formulating a list of mailboxes, I.P. addresses and/or mailbox/I.P. address combinations that can be relied upon as having good reputation. In addition, users can configure mail processing units to reject all messages from a certified domain that do not match a certified mailbox, a certified I.P. address, or a certified mailbox%I.P. address combination, or that contain any of the identified mailbox or I.P. addresses that were indicated as being “bad” by the domain administrator. Over time, the certification of mailboxes and I.P. addresses by domain administrators significantly reduces the number of tests, such as Silverlist and/or sender address verification tests, that are required to be issued by a mail processing unit to ascertain the reputation of unknown senders.

### Transmitting Reputation Information to Mail Processing Units

The global reputation information communicated to mail processing units in accordance with embodiments of the invention depends upon the global reputation information generated by the global address reputation system. In many embodiments, the global address reputation system uses the collected event information to assign a score to each known sender email address, sender domain, I.P. address, combination of sender email address and I.P. address, and combination of sender domain and I.P. address. The score can be a binary score indicating that the reputation is either “good”, or “unknown”. In several embodiments, the global reputation is assigned a score on a reputation scale. In a number of embodiments, a mixture of binary and scored reputations is used. The global address reputation server can then distribute an accept list to individual mail processing units based upon the determined global reputations. Each mail processing unit can specify a different profile for the level of global reputation required in order to automatically accept a message. In several embodiments, the mail processing unit also distributes a deny list containing a list of sender email addresses, sender domains, and/or I.P. addresses from which messages should be automatically rejected. Again, individual mail processing units can specify the criteria for constructing a deny list. In several embodiments, individual mail processing units can query the global address reputation server to obtain reputation information for a specific email address, sender domain, and/or I.P. address. In many embodiments, a mail processing unit uses an I.P. address and an email address to generate a single string, which may be obfuscated using a hash or encrypted, and the string is provided to the global address reputation server. The global address reputation server provides a reputation score in response to receipt of a reputation query based upon the I.P. address/email address pair. In other embodiments, any of a variety of techniques appropriate to a specific application can be used to request reputation information from a global address reputation server with respect to a specific sender, server and/or domain.

### Using Global Reputation Information to Accept Mail Messages

Global reputation information can relate to different aspects of a mail message. For example, a sender email address can have “good” global reputation, a sender domain can have “good” global reputation, an I.P. address can have “good” global reputation, a combination of sender email address and I.P. address can have a “good” global reputation, and a combination of domain and I.P. address can have a “good” reputation. In embodiments where mail processing units apply tests such as Silverlist and sender address verification tests, a message will only avoid tests based upon the I.P. address of the sender (e.g., a Silverlist test) provided the I.P. address of the sender possesses “good” global reputation and a message will only avoid sender address verification provided the sender email address of the sender possesses “good” global reputation. In many embodiments, users can also configure a mail processing system to accept messages from a sender within a domain that has a “good” global reputation without sender address verification.

### Improving Email Filters

A global address reputation system in accordance with an embodiment of the invention can also be used to enhance the effectiveness of conventional email filters. In a number of embodiments, the global address reputation server distributes accept and deny lists to email filters. In many embodiments, third parties can obtain global reputation information as a service. The information can be accessed via a web service, an HTTP post or get, an updated download or as part of a Domain Name System server infrastructure, where the global email address reputation system includes a DNS server that provides reputation information as part of a domain name lookup.

In many embodiments, the global address reputation system is used to construct email filters. Techniques similar to those used by email filters to classify the content of a message (e.g., hashes of different parts of a mail message) can be performed by mail processing units and reported as events to the global address reputation server for inclusion in the global address reputation database. Assuming a large number of deployed mail processing units, the global address reputation database rapidly builds an extremely large training dataset. In addition, the training dataset can be correlated against the global reputation of each sender. Using the global reputation of the sender of each message in the training data, the parameters for an email filter that is optimized to only allow messages from senders with “good” global reputation and minimizing false positives can be determined. Once the parameters of the email filters have been generated, the global address reputation server can distribute the filter parameters to email filters via the Internet.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. An electronic mail message processing system, comprising:
a plurality of mail servers configured to maintain user mail accounts from which electronic mail messages can be exchanged via a network;
a plurality of mail processing units connected to the network, where each mail processing unit acts as a gateway for at least one of the mail servers that filters incoming electronic mail messages;
a global address reputation server connected to a global address reputation database and configured to communicate with the mail processing units via the network;
wherein at least one of the mail processing units is configured to track events associated with the filtering of electronic mail messages and forward tracked event information to the global address reputation server;
wherein the global address reputation server is configured to store event information received from the mail processing units in the global address reputation database;
wherein the global address reputation server is configured to develop sender reputation information concerning message senders from the event information stored in the global address reputation database; and
wherein the global address reputation server is configured to provide sender reputation information concerning message senders to mail processing units;
wherein at least one of the mail processing units that receives sender reputation information from the global address reputation server is configured to utilize the sender reputation information when filtering messages based upon the message sender.

2. The electronic mail filtering system of claim 1, wherein each electronic mail message includes a sender email address, a sender domain, and a sender I.P. address that identify the message sender.

3. The electronic mail filtering system of claim 2, wherein the sender reputation information includes information concerning the reputation of a sender email address.

4. The electronic mail filtering system of claim 2, wherein the sender reputation information includes information concerning the reputation of a sender domain.

5. The electronic mail filtering system of claim 2, wherein the sender reputation information includes information concerning the reputation of a sender I.P. address.

6. The electronic mail filtering system of claim 2, wherein at least one of the mail processing units is configured to utilize at least one of the sender email address, sender domain and sender I.P. address of an incoming electronic mail message when filtering the incoming electronic mail message.

7. The electronic mail filtering system of claim 6, wherein the at least one mail processing unit is configured to forward incoming messages from senders known to have a good reputation to a mail server associated with the recipient of the message.

8. The electronic mail filtering system of claim 7, wherein the at least one mail processing units is configured to determine that a message sender has a good reputation when the sender email address, and sender I.P. address correspond to an email address and sender I.P. address pair entry on an accept list.

9. The electronic mail filtering system of claim 8, wherein the email address and sender I.P. address pair is expressed as a hash value on the accept list.

10. The electronic mail filtering system of claim 6, wherein at least one mail processing unit is configured to determine the reputation of senders that have an unknown reputation by performing a fundamental SMTP behavior test.

11. The electronic mail filtering system of claim 10, wherein:
the fundamental SMTP behavior test is a Silverlist test; and
at least one mail processing unit is configured to communicate the outcome of the Silverlist test to the global address reputation server.

12. The electronic mail filtering system of claim 11, wherein the at least one mail processing unit is configured to refuse to accept messages from senders that fail a SilverList test.

13. The electronic mail filtering system of claim 10, wherein the at least one mail processing unit is configured to determine the reputation of senders that have an unknown reputation by performing a challenge response test.

14. The electronic mail filtering system of claim 13, wherein the at least one mail processing unit is configured to reject messages when a sender fails a challenge response test.

15. The electronic mail filtering system of claim 13, wherein the at least one mail processing unit is configured to communicate the outcome of the challenge response test to the global address reputation server.

16. The electronic mail filtering system of claim 13, wherein the at least one mail processing unit is configured to determine that a sender has a good reputation when the sender passes a fundamental SMTP behavior test and a challenge response test.

17. The electronic mail filtering system of claim 7, wherein the at least one mail processing unit is configured to filter incoming messages from senders of unknown reputation using a content based filter.

18. The electronic mail filtering system of claim 2, wherein the global address reputation system is configured to build a profile of a domain using reputation information provided to the global address reputation system by at least one of the mail processing units.

19. The electronic mail filtering system of claim 18, wherein the global address reputation system is configured to build a profile of a domain that includes the I.P. addresseses associated with the domain using reputation information provided by at least one of the mail processing units that identifies at least one I.P. address from which messages from the domain were sent.

20. The electronic mail filtering system of claim 18, wherein the global address reputation system is configured to build a profile of a domain that includes the sender email addresses associated with the domain using reputation information provided by at least one mail processing unit that identifies at least one sender email address associated with messages sent from the domain.

21. The electronic mail filtering system of claim 18, wherein the global address reputation system is configured to build a profile of a domain that includes the sender email addresses and I.P. addresses associated with the domain using reputation information provided by at least one mail processing unit that identifies at least one sender email addresses and I.P. address associated with messages sent from the domain.

22. The electronic mail filtering system of claim 21, wherein the global address reputation system is configured to enable a domain administrator to edit a domain profile and certify the accuracy of the domain profile.

23. The electronic mail filtering system of claim 22, wherein:
the global address reputation system is configured to distribute certified domain profiles to at least one of the mail processing units; and
the at least one mail processing unit is configured to use the certified domain profiles to filter messages from senders of unknown reputation.

24. The electronic mail filtering system of claim 1, wherein:
at least one of the mail processing units is configured to request sender reputation information from the global address reputation system via the network in response to an incoming electronic mail message from a sender of unknown reputation;
the global address reputation system is configured to respond to a request from a mail processing unit by providing sender reputation information to the requesting mail processing unit; and
the at least one mail processing unit is configured to utilize the sender reputation information when filtering the electronic mail message from the sender of unknown reputation.

25. The electronic mail filtering system of claim 1, wherein at least one of the mail processing units is configured to store global address reputation information received from the global address reputation server for later use in the filtering of messages from senders of unknown reputation.

26. The electronic mail filtering system of claim 1, wherein at least one of the mail processing units is configured to observe endorsements of a sender and communicate the endorsements to the global address reputation system.

27. The electronic mail filtering system of claim 26, wherein the at least one mail processing unit is configured to record a user sending an outgoing message addressed to a sender email address through a mail processing unit from a mail server where the user maintains a user account as an endorsement of the sender email address.

28. The electronic mail filtering system of claim 26, wherein the at least one mail processing unit is configured to record the addition of a sender email address to a list of contacts on a mail server where a user has an email account and for which the mail processing unit acts as a gateway device as an endorsement of the sender email address.

29. The electronic mail filtering system of claim 26, wherein the at least one mail processing unit is configured to record a user instruction to the mail processing unit to forward a message held by the mail processing unit that was sent by a sender as an endorsement of the sender.

30. The electronic mail filtering system of claim 1, wherein the global address reputation server is configured to provide devices that are not part of the electronic mail filtering system with access to global reputation information.

31. A method of filtering mail messages, comprising:
receiving inbound messages prior to receipt by a mail server;
accepting messages where the sender of the message is known to have good reputation;
observing the actions of senders of unknown reputation in response to at least one test intended to verify that the sender and the sender's mail server behave in a manner consistent with a sender of good reputation;
forwarding reputation information including observed actions of senders in response to at least one test to a global address reputation system;
receiving global reputation information from the global address reputation system; and
determining senders known to have good reputation using the global reputation information.

32. A method of building a profile of a domain, comprising:
receiving inbound messages prior to receipt by one of a plurality of mail servers, where each of the messages includes an I.P. address, and a sender email address including a domain;
filtering the messages based upon reputation formed by observing the actions of the sender including the sender's responses to at least one test intended to verify that the sender and the sender's mail server behave in a manner consistent with a sender of good reputation;
recording the I.P. address, sender email address, and domain of received messages; and
building a profile of a domain that includes the I.P. addresses and sender email addresses of all messages received from the domain and the reputation of the I.P. addresses and sender email addresses.

33. The method of claim 32, further comprising:
granting an authorized domain administrator access to edit the profile; and
allowing the authorized domain administrator to certify the accuracy of the profile.
